(19) United States
(12) Patent Application Publication
(10) Pub. No.: US 2026/0329791 A1
(43) Pub. Date: Oct. 22, 2026

(54) OPTICAL NAVIGATION DEVICE WITH AGGRESSIVE POWER MANAGEMENT AND OPERATING METHOD THEREOF

(71) Applicant: PIXART IMAGING INC., Hsin-Chu County (TW)

(72) Inventors: Yen-Hsiang CHEW, Penang (MY); Willie SONG, Penang (MY)

(21) Appl. No.: 19/181,329

(22) Filed: Apr. 17, 2025

(51) Int. Cl. G06F 13/362; G06F 13/42

(52) U.S. Cl. CPC G06F 13/362; G06F 13/4282

(57) ABSTRACT

There is provided an optical navigation device including a navigation sensor and a host processor. The navigation sensor and the host processor communicate to each other via an SPI interface, a motion line and a GPIO line. When an NCS pin of the SPI interface is at a high voltage level, the navigation sensor transmits power management information to the host processor via the motion line and/or a MISO line of the SPI interface to determine a mode of aggressive power management of the host processor.

### FIELD OF THE DISCLOSURE

This disclosure generally relates to an optical navigation device and, more particularly, to an optical navigation device that uses a serial peripheral interface and/or a motion line thereof to transmit different aggressive power management information to cause a host processor of the optical navigation device to have different wakeup times, and an operating method of the optical navigation device.

### BACKGROUND OF THE DISCLOSURE

A 4-wire serial peripheral interface (SPI) generally includes a master-in-slave-out (MISO) pin, a master-out-slave-in (MOSI) pin, an SCLK pin and an NCS pin. The SCLK pin is used to transmit and receive a clock signal SCLK. The NCS pin is used to assert whether the 4-wire SPI is active or inactive.

The optical navigation device adopts the 4-wire SPI interface may further include a motion pin and a general purpose I/O (GPIO) pin. The motion pin is used to assert a motion signal to cause the 4-wire SPI interface to transmit displacement data when a device motion is detected. The GPIO pin is used to transmit addition information.

However, with limited package size and package cost, a sensor chip may be arranged with only one GPIO pin, and said one GPIO pin may not be able to fulfill the requirement of transmitting aggressive power management information.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an optical navigation device that is arranged to transmit power management information via a motion pin and/or a MISO pin when the NCS pin of an SPI interface is at a high voltage level, and an operating method of the optical navigation device.

The present disclosure further provides an optical navigation device in which a MISO pin of an SPI slave interface of a navigation sensor thereof is coupled to both of a MISO pin of an SPI master interface and a GPIO pin of a host processor thereof, and an operating method of the optical navigation device.

The present disclosure provides an optical navigation device including a sensor and a processor. The processor is configured to communicate with the sensor via a serial parallel interface (SPI). A master-in-slave-out (MISO) pin of an SPI slave interface of the sensor is coupled to both of a general purpose I/O (GPIO) pin and a MISO pin of an SPI master interface of the processor. The sensor is configured to assert an interrupt signal to another GPIO pin of the processor via a GPIO line to inform the processor to enter aggressive power management.

The present disclosure further provides an operating method of an optical navigation device, which includes a sensor and a processor communicating to each other via a serial parallel interface (SPI interface), a motion line and a general purpose I/O (GPIO) line. The operating method includes the steps of: pulling low a voltage level of the GPIO line using the sensor; asserting, by the sensor, an interrupt signal to the processor via the GPIO line upon an NCS pin of an SPI master interface of the processor is at a high voltage level; transmitting, by the sensor, power management information to the processor via at least one of the motion line and a MISO line of the SPI interface; and controlling the processor to enter aggressive power management according to the aggressive power management information.

The present disclosure further provides an operating method of an optical navigation device, which includes a sensor and a processor communicating to each other via a serial parallel interface (SPI interface), a motion line and a general purpose I/O (GPIO) line. The operating method includes the steps of: waiting an NCS pin of an SPI master interface of the processor to change to a high voltage level upon the NCS pin being at a low voltage level; asserting, by the sensor, an interrupt signal to the processor via the GPIO line upon the NCS pin changing to the high voltage level; transmitting, by the sensor, power management information to the processor via at least one of the motion line and a MISO line of the SPI interface; and controlling the processor to enter aggressive power management according to the aggressive power management information.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic block diagram of a wireless optical navigation device according to one embodiment of the present disclosure.

FIG. 2 is a signal timing diagram of an operating method of waking up a fundamental idle mode of a host processor of an optical navigation device according to one embodiment of the present disclosure.

FIG. 3 is a signal timing diagram of an operating method of an SPI interface of an optical navigation device according to one embodiment of the present disclosure.

FIG. 4 is a signal timing diagram of an operating method of an SPI interface of an optical navigation device according to another embodiment of the present disclosure.

FIG. 5 is a signal timing diagram of an operating method of waking up an aggressive idle mode of a host processor of an optical navigation device according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide an optical navigation device that repurposes functions of a maser-in-slave-out (MISO) pin of a serial parallel interface (SPI interface) and a motion pin, and an operating method of the optical navigation device. The present disclosure uses the MISO pin and the motion pin to transmit aggressive power management information when the SPI interface is in an inactive state to cause a host processor to have different wakeup times corresponding to different rest states (i.e. aggressive power management states) of a navigation sensor so as to improve the power usage efficiency.

In the present disclosure, modes of the aggressive power management includes at least one of: mode 1: clock/power gating a direct memory access (DMA) engine of the host processor or setting the DMA engine to a low power state; mode 2: clock/power gating a host processor's SPI master interface or setting the SPI master interface to a low power state; mode 3: clock/power gating a wireless module coupled to the host processor or setting the wireless module to a low power state; and mode 4: clock/power gating one or more sub-modules of the host processor or setting the sub-modules to a low power state, wherein the sub-modules include cores, cache, memories and other circuits of the host processor.

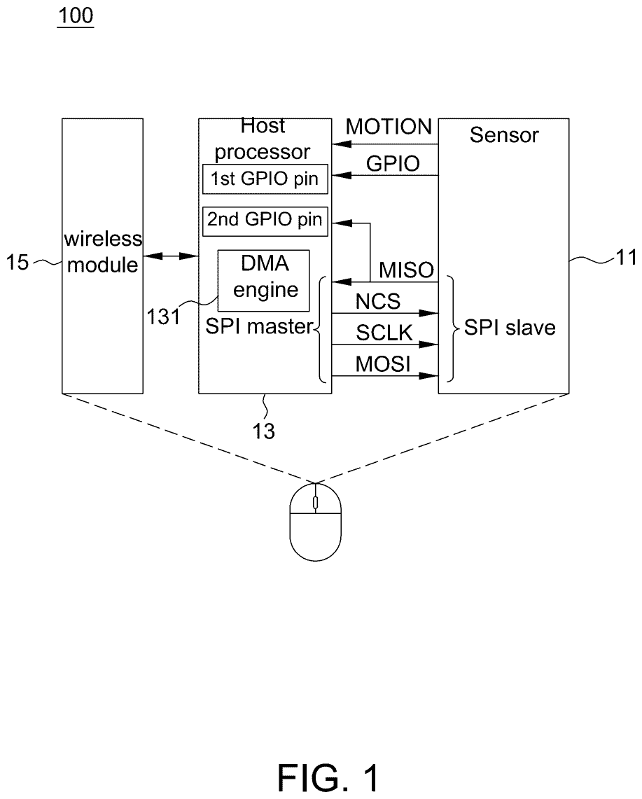

Please refer to FIG. 1, it is a schematic block diagram of a wireless optical navigation device (sometimes abbreviated as optical navigation device) 100 according to one embodiment of the present disclosure. The wireless optical navigation device 100 includes a sensor 11, a host processor (sometimes abbreviated as processor) 13 and a wireless module 15. The processor 13 is communicatively coupled to the sensor 11 and the wireless module 15. The optical navigation device 100 is, for example, an optical mouse device, an optical tracking sensor (OTS) or an optical finger navigator (OFN), but not limited to.

The sensor 11 is, for example, an optical sensor including a CMOS image sensor, a CCD image sensor or a single photon avalanche diode (SPAD) image sensor, but not limited thereto. The sensor 11 is used as a navigation sensor, e.g., including a processor such as a digital signal processor (DSP), an application integrated circuit (ASIC) or a field programmable gate array (FPGA) to calculate displacement according to image frames and output displacement data. The method of calculating displacement by a processor is known to the art, e.g., comparing different image frames, and not a main objective of the present disclosure, and thus details thereof are not described herein.

The processor 13 is, for example, but not limited to, a micro controller unit (MCU) or a microprocessor unit (MPU) that uses software, firmware and/or hardware to perform functions thereof.

The wireless module 15 includes a wireless communication chip, e.g., Bluetooth communication chip, a Bluetooth Low Energy (BLE) chip or RF communication chip, for coupling to an external computer (not shown). The external computer is not particular limited, e.g., selected from a notebook computer, a desktop computer, a tablet computer, a central control system, a work station or the like as long as said external computer includes another wireless communication chip to communicate with the wireless module 15.

As shown in FIG. 1, the sensor 11 and the processor 13 communicate to each other using a serial parallel interface, a motion line (e.g., shown as MOTION) and a GPIO line (e.g., shown as GPIO). The sensor 11 includes an SPI slave interface (e.g., shown as SPI slave). The processor 13 includes an SPI master interface (e.g., shown as SPI master).

The motion line is connected between a motion pin of the sensor 11 and a motion pin of the processor 13. The GPIO line is connected between a GPIO pin of the sensor 11 and a first GPIO pin (shown as 1st GPIO pin) of the processor 13.

A MISO pin of the SPI slave interface of the sensor 11 is coupled to both of a second GPIO pin (shown as 2nd GPIO pin) and a MISO pin of the SPI master interface of the processor 13 via an MISO line (e.g., shown as MISO).

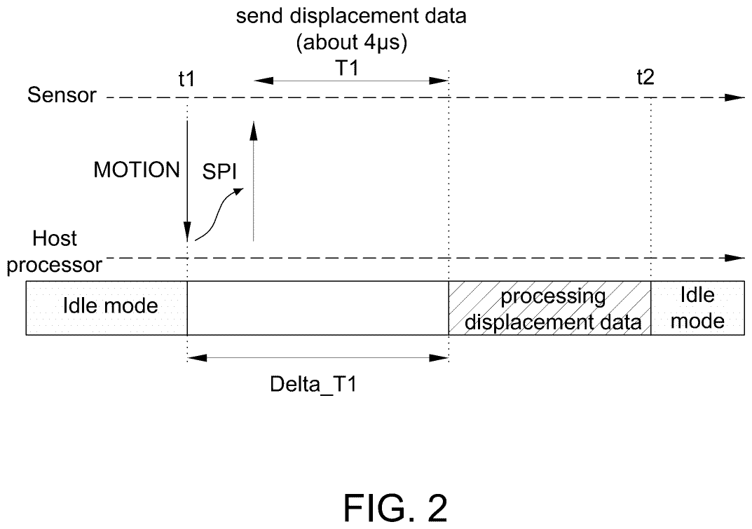

Please refer to FIG. 2, it is a signal timing diagram of an operating method of waking up a fundamental idle mode of a host processor 13 of an optical navigation device 100 according to one embodiment of the present disclosure.

When the processor 13 is in a fundamental idle mode (only shown as idle mode) and when the motion pin asserts a motion (e.g., at time t1), a direct memory access (DMA) engine 131 of the processor 13 reads displacement data from the sensor 11 via the SPI interface, and invokes the processor 13 to process the displacement data and transmits the processed data to an external computer. After the displacement data is processed (e.g., at time t2), the processor 13 returns to the fundamental idle mode.

The DMA engine 13 needs to remain active and ready to detect an asynchronous motion signal sent from the motion line. Generally, the processor 13 needs to accomplish a transition from the idle mode to an active state within a time interval Delta_T1, e.g. about 4 μs, to avoid delay in processing the displacement data. In other words, in the present disclosure, the fundamental idle mode is referred to a mode, e.g., any one of the mode 1 to mode 4 mentioned above, that uses a wakeup time of terminating the idle mode of the processor smaller than or equal to 4 μs (possibly more shorter in a gaming optical navigation). Due to this time limitation, the processor 13 is limited not able to perform aggressive power management and thus total saving power is limited.

Therefore, the present disclosure provides an optical navigation device whose sensor 11 informs the processor 13 to enter a deeper sleep according to an operating state (e.g., including lifted and motionless time) thereof to realize aggressive power management. It is appreciated that waking from a deeper sleep needs more time.

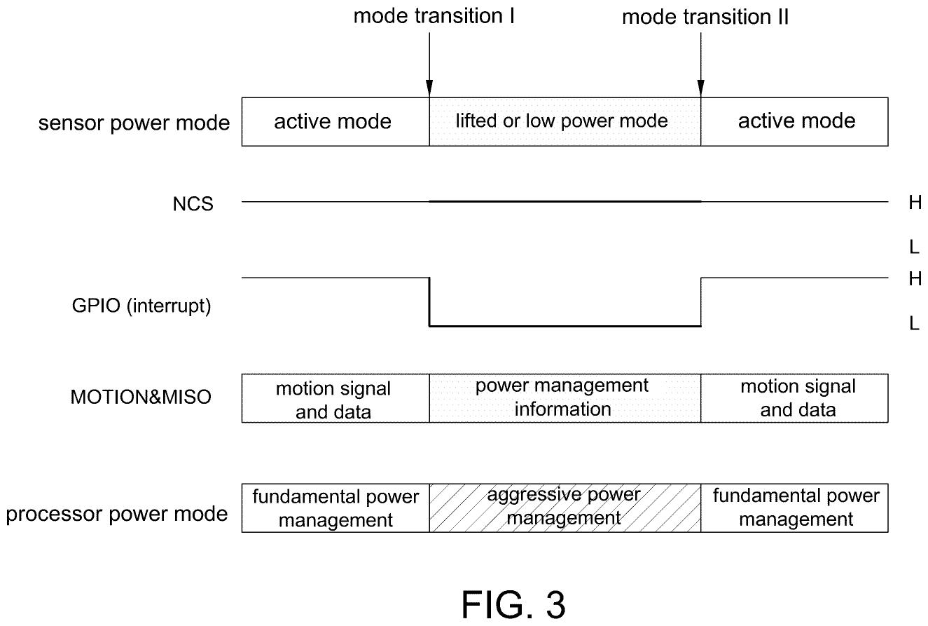

Please refer to FIGS. 1 and 3, FIG. 3 is a signal timing diagram of an operating method of the SPI interface of an optical navigation device 100 according to one embodiment of the present disclosure.

In the present disclosure, at a mode transition I (e.g., optical navigation device 100 lifted from work surface or changing from run to rest), the sensor 11 asserts an interrupt signal using the GPIO line, e.g., changing from a high voltage level to a low voltage level, to a first GPIO pin of the processor 13 to inform the processor 13 to enter aggressive power management. In addition, at a mode transition II (e.g., optical navigation device 100 putting on work surface or changing from rest to run), the sensor 11 asserts an interrupt ending signal using the GPIO line, e.g., changing from the low voltage level to the high voltage level, to the first GPIO pin of the processor 13 to inform the processor 13 to terminate the aggressive power management.

In an aspect that the aggressive power management includes four modes. When the sensor 11 asserts the interrupt signal and an NCS pin of the SPI master interface is at a high voltage level, the sensor 11 transmits aggressive power management information to the processor 13 to determine a mode of the aggressive power management via the MISO line of the SPI interface and the motion line.

For example referring to Table I below, when the sensor 11 enters a state REST I, the aggressive power management information includes, e.g., (0,0), wherein the processor 13 enters one of the above mode 1 to mode 4 corresponding to the state REST I. When the sensor 11 enters a state REST II, the aggressive power management information includes, e.g., (0,1), wherein the processor 13 enters two of the above mode 1 to mode 4 corresponding to the state REST II. When the sensor 11 enters a state REST III, the aggressive power management information includes, e.g., (1,0), wherein the processor 13 enters three of the above mode 1 to mode 4 corresponding to the state REST III. When the sensor 11 is lifted, the aggressive power management information includes, e.g., (1,1), wherein the processor 13 enters all of the above mode 1 to mode 4 corresponding to the state Lifted. Which of the REST I to REST III that the sensor 11 enters is determined, for example, according to a time interval that the optical navigation device 100 is motionless. In Table I, the Motion line row indicates information sent via the motion line, and the MISO line row indicates information sent via the MISO line.

It should be mentioned that a mode of the aggressive power management that the processor 13 enters/selects corresponding to every state of the sensor 11 is not limited to those mentioned above. The processor 13 may be arranged to run any different combinations of mode 1 to mode 4 corresponding to each state of the sensor 11 without particular limitations.

TABLE I

| Sensor State | REST I | REST II | REST III | Lifted |
|---|---|---|---|---|
| Motion line | 0 | 0 | 1 | 1 |
| MISO line | 0 | 1 | 0 | 1 |
| Reaction time T2 | 2 ms | 20 ms | 1 s | >1 s |

It should be mentioned that although Table I shows that the aggressive power management information includes two bits, it is only intended to illustrate but not to limit the present disclosure. The aggressive power management information may be defined by more than two bits.

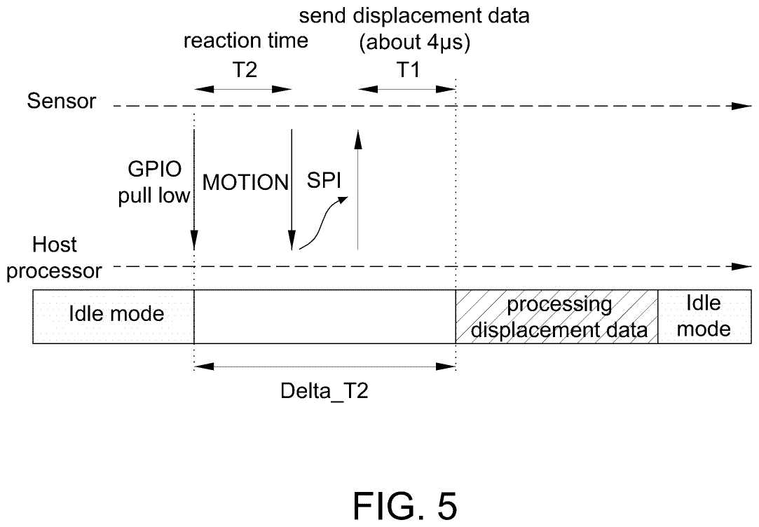

Please refer to FIG. 5, it is a signal timing diagram of an operating method of waking up an aggressive idle mode (only shown as idle mode) of a host processor 13 of an optical navigation device 100 according to one embodiment of the present disclosure. It is seen from FIG. 5 that besides the time interval T1 (identical to T1 in FIG. 2), the wakeup time Delta_t2 (=T1+T2) further includes a reaction time T2. It is seen from the above Table I that the reaction time T2 is different corresponding to every state of the sensor 11. That is, a wakeup time (e.g., shown as Delta_T2) that the processor 13 terminates the aggressive power management is different corresponding to a current mode (e.g., the mode of the aggressive power management corresponding to the state REST I to REST III and Lifted in Table 1) of the aggressive power management.

In the present disclosure, the sensor 11 informs the processor 13 about the time, i.e. Delta_T2, that displacement data is sent using the aggressive power management information such that the processor 13 needs not to wake up after the time interval Delta_T1 as shown in FIG. 2 because the sensor 11 does not start to send the displacement data so early. In this way, the processor 13 disables more components, e.g., those mentioned in the above mode 1 to mode 4, to reduce the total power consumption.

However, a number of states of the sensor 11 is not limited to four as shown in Table I.

For example, in an aspect that the aggressive power management includes two modes, the sensor 11 transmits aggressive power management information (e.g., two in Table I) to the processor 13 via the motion line to determine a mode of the aggressive power management when the sensor 11 asserts an interrupt signal, e.g., GPIO shown in FIG. 3 changing from High to Low at mode transition I. In this aspect, the aggressive power management information is sent only via the motion line without via the MISO line of the SPI interface such that it is not necessary to consider whether the MISO line is active or not.

For example, in another aspect that the aggressive power management includes two modes, the sensor 11 transmits aggressive power management information (two in Table I) to the processor 13 via an MISO line of the SPI interface to determine a mode of the aggressive power management when the sensor 11 asserts an interrupt signal, e.g., GPIO shown in FIG. 3 changing from High to Low at mode transition I and an NCS pin of the SPI interface is at a high voltage level. In this aspect, the aggressive power management information is sent only via the MISO line of the SPI interface without via the motion line such that it is still required to consider whether the MISO line is active or not, e.g., MISO being not active when the NCS is High.

FIG. 3 shows an operating method an optical navigation device 100 according to one embodiment of the present disclosure, including the steps of: pulling low a voltage level of a GPIO line using a sensor 11, e.g., at mode transition I (e.g., optical navigation device 100 lifted from work surface or changing from run to rest); asserting, by the sensor 11, an interrupt signal (e.g., GPIO from High to Low) to the processor 13 via the GPIO line upon an NCS pin of an SPI master interface of the processor 11 is at a high voltage level; transmitting, by the sensor 11, power management information (e.g., at least two in Table I) to the processor 13 via at least one of the motion line and a MISO line of the SPI interface; controlling the processor 13 to enter aggressive power management (e.g., at least one of the above mode 1 to mode 4) according to the aggressive power management information; pulling high the voltage level of the GPIO line using the sensor 11, e.g., at mode transition II (e.g., optical navigation device 100 putting on work surface or changing from rest to run); and controlling the processor 13 to terminate the aggressive power management, e.g., FIG. 5 showing the displacement data being processed after a wakeup time Delta_T2.

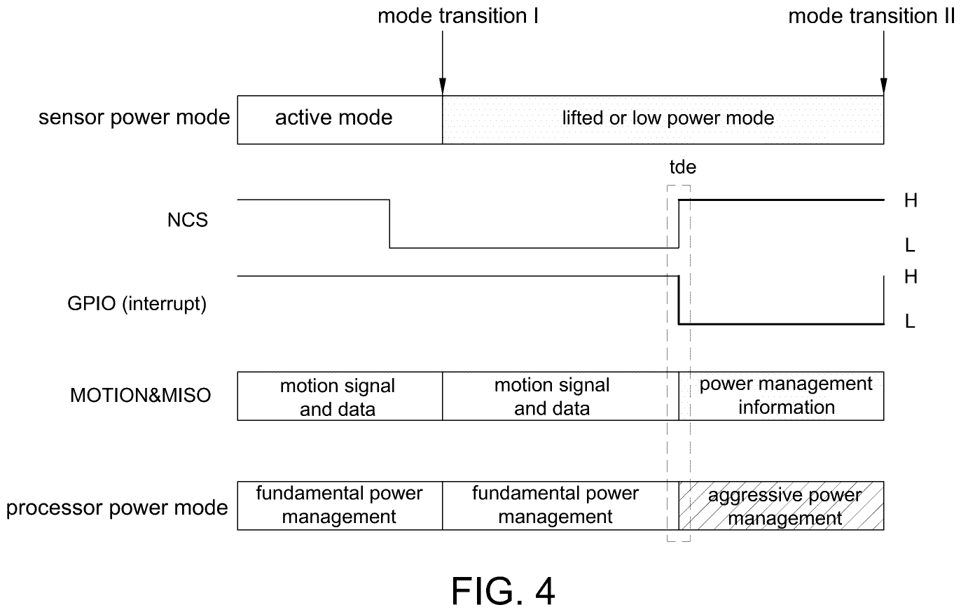

Please refer to FIGS. 1 and 4, FIG. 4 is a signal timing diagram of an operating method of the SPI interface of an optical navigation device 100 according to another embodiment of the present disclosure. The difference between FIG. 4 and FIG. 3 is that in FIG. 4 when the sensor 11 detects a mode transition I (e.g., lifted from work surface or changing from run to rest), the NCS pin is at a low voltage level indicating that the SPI interface is still in an active state and thus the aggressive power management information cannot be directly sent thereby. In this case, the aggressive power management information is not sent until the NCS is changed to a high voltage level.

In an aspect that the aggressive power management includes four modes. When the NCS pin of the SPI master interface is at a low voltage level, even though the sensor 11 detects a mode transition I, the sensor 11 waits the NCS changing to a high voltage level (e.g., at time tde) to assert an interrupt signal (e.g., GPIO changing from High to Low) and to transmit aggressive power management information (e.g., the four in Table I, but not limited to) to the processor 13 to determine a mode of the aggressive power management via the MISO line of the SPI interface and the motion line.

In an aspect that the aggressive power management includes only two modes. When the NCS pin of the SPI master interface is at a low voltage level, even though the sensor 11 detects a mode transition I, the sensor 11 waits the NCS changing to a high voltage level (e.g., at time tde) to assert an interrupt signal (e.g., GPIO changing from High to Low) and to transmit aggressive power management information (e.g., any two in Table, but not limited to) to the processor 13 to determine a mode of the aggressive power management via the MISO line of the SPI interface. In this aspect, the aggressive power management information is sent only via the MISO line of the SPI interface without via the motion line such that it is still required to consider whether the MISO line is active or not, e.g., MISO being not active when the NCS is High.

FIG. 4 shows an operating method of the optical navigation device 100, including the steps of: waiting an NCS pin of an SPI master interface of a processor 13 to change to a high voltage level upon the NCS pin being at a low voltage level; asserting, by a sensor 11, an interrupt signal (e.g., GPIO changing from High to Low) to the processor 13 via a GPIO line upon the NCS pin changing to the high voltage level, e.g., at time tde; transmitting, by the sensor 13, power management information (e.g., at least two in Table I) to the processor 11 via at least one of a motion line and a MISO line of the SPI interface; controlling the processor 13 to enter aggressive power management (e.g., at least one of the above mode 1 to mode 4, corresponding a state of the sensor 11) according to the aggressive power management information; pulling high the voltage level of the GPIO line using the sensor 11, e.g., at mode transition II (e.g., optical navigation device 100 putting on work surface or changing from rest to run); and controlling the processor 13 to terminate the aggressive power management, e.g., FIG. 5 showing the displacement data being processed after a wakeup time Delta_T2.

The method of detecting a motionless time and lifted state is known to the art and not a main objective of the present disclosure, and thus details thereof are not described herein.

It should be mentioned that although the above embodiments are described by a 4-wire SPI interface as an example, the present disclosure is not limited thereto. The optical navigation device of the present disclosure may employ a 2-wire SPI interface or a 3-wire SPI interface without particular limitations.

It should be mentioned that although the above embodiments are described by using a wireless optical navigation device as an example, the present disclosure is not limited thereto. The optical navigation device of the present disclosure may be a wired optical navigation device by changing the wireless module 15 with a wired module (e.g., having a USB interface, but not limited to) to perform wire transmission with an external computer.

It should be mentioned that values mentioned in the present disclosure, e.g., bits of power management information and reaction times of the host processor, are only intended to illustrate but not to limit the present disclosure.

As mentioned above, due to the consideration of the size and cost, a sensor chip conventionally is arranged with a single GPIO pin such that signal content can be transmitted is limited. Accordingly, the present disclosure further provides an optical navigation device (e.g., FIG. 1) in which a MISO pin of a sensor is coupled to both of a MISO pin and a second GPIO pin of a host processor, and an operating method of the optical navigation device (e.g., FIGS. 3-5). In this way, when an NCS pin of the SPI interface is at a low voltage level, an MISO pin of the sensor is used to transmit displacement data (i.e. conventional read operation of SPI interface); whereas, when the NCS pin is at a high voltage level, the MISO pin and/or a motion pin of the sensor is used to output power management information so as to solve the problem of not having enough numbers of pins. By using different content of the power management information, the host processor may enter different degrees of sleeping to improve the power usage efficiency.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. An optical navigation device, comprising:
a sensor; and
a processor, configured to communicate with the sensor via a serial parallel interface (SPI interface),
wherein, a master-in-slave-out (MISO) pin of an SPI slave interface of the sensor is coupled to both of a general purpose I/O (GPIO) pin and a MISO pin of an SPI master interface of the processor, and
the sensor is configured to assert an interrupt signal to another GPIO pin of the processor via a GPIO line to inform the processor to enter aggressive power management.

2. The optical navigation device as claimed in claim 1, wherein the sensor is further configured to transmit aggressive power management information to the processor via a motion line to determine a mode of the aggressive power management upon the sensor asserting the interrupt signal.

3. The optical navigation device as claimed in claim 1, wherein the sensor is further configured to transmit aggressive power management information to the processor via an MISO line of the SPI interface to determine a mode of the aggressive power management upon the sensor asserting the interrupt signal and an NCS pin of the SPI master interface being at a high voltage level.

4. The optical navigation device as claimed in claim 1, wherein when an NCS pin of the SPI master interface is at a low voltage level, the sensor is further configured to wait the NCS pin to change to a high voltage level to assert the interrupt signal and transmit aggressive power management information to the processor via an MISO line of the SPI interface to determine a mode of the aggressive power management.

5. The optical navigation device as claimed in claim 1, wherein the sensor is further configured to transmit aggressive power management information to the processor via an MISO line of the SPI interface and a motion line to determine a mode of the aggressive power management upon the sensor asserting the interrupt signal and an NCS pin of the SPI master interface being at a high voltage level.

6. The optical navigation device as claimed in claim 1, when an NCS pin of the SPI master interface is at a low voltage level, the sensor is further configured to wait the NCS pin to change to a high voltage level to assert the interrupt signal and transmit aggressive power management information to the processor via an MISO line of the SPI interface and a motion line to determine a mode of the aggressive power management.

7. The optical navigation device as claimed in claim 1, wherein modes of the aggressive power management comprises at least one of
clock gating or power gating a direct memory access (DMA) engine of the processor or setting the DMA engine to a low power state;
clock gating or power gating the SPI master interface of the processor or setting the SPI master interface to a low power state;
clock gating or power gating a wireless module coupled to the processor or setting the wireless module to a low power state; and
clock gating or power gating one or more sub-modules of the processor or setting the sub-modules to a low power state.

8. The optical navigation device as claimed in claim 7, wherein the sensor is further configured to assert an interrupt ending signal to the another GPIO pin of the processor via the GPIO line to inform the processor to terminate the aggressive power management.

9. The optical navigation device as claimed in claim 8, wherein a wakeup time that the processor terminates the aggressive power management is different corresponding to a current mode of the aggressive power management.

10. An operating method of an optical navigation device, the optical navigation device comprising a sensor and a processor communicating to each other via an SPI interface, a motion line and a GPIO line, the operating method comprising:
pulling low a voltage level of the GPIO line using the sensor;
asserting, by the sensor, an interrupt signal to the processor via the GPIO line upon an NCS pin of an SPI master interface of the processor is at a high voltage level;
transmitting, by the sensor, power management information to the processor via at least one of the motion line and a MISO line of the SPI interface; and
controlling the processor to enter aggressive power management according to the aggressive power management information.

11. The operating method as claimed in claim 10, further comprising:
pulling high the voltage level of the GPIO line using the sensor; and
controlling the processor to terminate the aggressive power management.

12. The operating method as claimed in claim 11, wherein a wakeup time that the processor terminates the aggressive power management is different corresponding to a current mode of the aggressive power management.

13. The operating method as claimed in claim 10, wherein modes of the aggressive power management comprises at least one of
clock gating or power gating a direct memory access (DMA) engine of the processor or setting the DMA engine to a low power state;
clock gating or power gating the SPI master interface of the processor or setting the SPI master interface to a low power state;
clock gating or power gating a wireless module coupled to the processor or setting the wireless module to a low power state; and
clock gating or power gating one or more sub-modules of the processor or setting the sub-modules to a low power state.

14. The operating method as claimed in claim 10, wherein a MISO pin of an SPI slave interface of the sensor is coupled to both of a GPIO pin and a MISO pin of the SPI master interface of the processor.

15. An operating method of an optical navigation device, the optical navigation device comprising a sensor and a processor communicating to each other via an SPI interface, a motion line and a GPIO line, the operating method comprising:
waiting an NCS pin of an SPI master interface of the processor to change to a high voltage level upon the NCS pin being at a low voltage level;
asserting, by the sensor, an interrupt signal to the processor via the GPIO line upon the NCS pin changing to the high voltage level;
transmitting, by the sensor, power management information to the processor via at least one of the motion line and a MISO line of the SPI interface; and
controlling the processor to enter aggressive power management according to the aggressive power management information.

16. The operating method as claimed in claim 15, further comprising:
pulling high the voltage level of the GPIO line using the sensor; and
controlling the processor to terminate the aggressive power management.

17. The operating method as claimed in claim 16, wherein a wakeup time that the processor terminates the aggressive power management is different corresponding to a current mode of the aggressive power management.

18. The operating method as claimed in claim 15, wherein modes of the aggressive power management comprises at least one of
clock gating or power gating a direct memory access (DMA) engine of the processor or setting the DMA engine to a low power state;
clock gating or power gating the SPI master interface of the processor or setting the SPI master interface to a low power state;
clock gating or power gating a wireless module coupled to the processor or setting the wireless module to a low power state; and
clock gating or power gating one or more sub-modules of the processor or setting the sub-modules to a low power state.

19. The operating method as claimed in claim 15, wherein a MISO pin of an SPI slave interface of the sensor is coupled to both of a GPIO pin and a MISO pin of the SPI master interface of the processor.
